(19) United States
(12) Patent Application Publication
(10) Pub. No.: US 2010/0151226 A9
(43) Pub. Date: Jun. 17, 2010

(54) Carpet backings prepared from hydroxylated vegetable oil-based polyurethanes

(76) Inventors: Larry E. Mashburn, RockyFace, GA (US); Thomas Edward Patterson, Tunnel Hill, GA (US); William H. Harrison, Dalton, GA (US)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 11/441,445

(22) Filed: May 26, 2006

Related U.S. Application Data
(63) Continuation-in-part of application No. 10/097,439, filed on Mar. 15, 2002, now abandoned.

(51) Int. Cl. B32B 3/00

(52) U.S. Cl. 428/316.6; 428/317.9; 521/137

(57) ABSTRACT

A textile having at least one adherent polyurethane backing, the backing being prepared from a polyurethane forming composition which comprises: (A) a polyisocyanate and (B) a mixture of a hydroxylated vegetable oil having a functionality of 1-4 and a blowing agent.

### BACKGROUND OF THE INVENTION

1. Field of the Invention

This invention relates to plastic elastomers and their method of preparation. Specifically, the present invention relates to flexible urethane foams and elastomers, useful as environmentally friendly carpet backings, prepared by the reaction between isocyanates and vegetable oils.

2. Description of the Prior Art

Because of their widely ranging mechanical properties and their ability to be relatively easily machined and formed, plastic foams and elastomers have found wide use in a multitude of industrial and consumer applications. In particular, urethane foams and elastomers have been found to be well suited for many applications. Automobiles, for instance, contain a number of components, such as cabin interior parts, that are comprised of urethane foams and elastomers. Such urethane foams are typically categorized as flexible (or semi-rigid) or rigid foams, with flexible foams generally being softer, less dense, more pliable and more subject to structural rebound than rigid foams.

Various methods for the production of polyurethane backing on textiles for floor coverings, including carpets are known and described in, for example, U.S. Pat. Nos. 3,849,156, 4,035,529, 4,657,790 and 4,853,280. The process of U.S. Pat. No. 3,849,156 comprises applying a froth directly to the back of carpeting, shaping the froth into the desired shape, and curing the shaped froth at a temperature of at least 70° C. to form a polyurethane foam backing on the carpeting material. This polyurethane comprises a substantially non-aqueous mixture of a polyisocyanate, an active hydrogen-containing material, an organosilicon surfactant, and a catalyst having substantial activity only at temperatures of at least 70° C. An inert gas is dispersed throughout the mixture by mechanical beating of the mixture to form a heat curable froth. Carpet fibers and textile filaments may not be firmly enough locked into the carpeting by these mechanically frothed foams, i.e., the “tuft lock” strength may be too low to maintain integrity of the carpet under heavy use conditions.

U.S. Pat. No. 4,035,529 describes a process using two coats of polyurethane backings for floor coverings having improved fixing of textile filaments, i.e., higher “tuft lock”, and increased stiffness of the carpet. This process comprises applying a first coat to a textile floor covering, a precoat, which consists essentially of a polyol and a large excess of an isocyanate. To assure good intercoat adhesion between coats, a foamable main coat of substantially equivalent amounts of a polyol and an isocyanate are then applied before the first coat is hardened, and both coats are subsequently hardened in a heating zone. The “open time”, that is, the time that elapses between application of the precoat and the foamable main coat is limited.

U.S. Pat. No. 4,657,790 relates to the use of general polyurethane formulation in a specific process. This process comprises forming a precoat layer of a reaction mixture comprising a curable polymer-forming composition, separately forming a capcoat layer of a mixture comprising a curable polymer forming composition, contacting the precoat layer with one surface of the substrate before the precoat layer is tack free, contacting the capcoat layer with one surface of the precoat layer before either the precoat layer or the capcoat layer is tack free, completing the curing of the capcoat and precoat layers, and cooling the polymer backed substrate to less than about 35° C. before mechanical distortion. This process is carried out under conditions such that mechanically induced stress is minimized. This process has the disadvantage that the capcoat is produced separately and then laminated to the precoat in an additional manufacturing step.

The multi-layered polymer backed floor covering of U.S. Pat. No. 4,853,280 is releasable. It allows the entire installed carpet or carpet padding to be easily removed from the floor surface without tearing so that portions of it do not remain on the floor surface. The backing comprises a facing layer and a bottommost release backing layer both comprising a non-woven fabric, and a polymer layer bonded to the release layer on one side and directly or indirectly to the facing layer on the other side. A precoat layer may be used between the facing layer and the polymer layer. This backing is produced by applying a layer of an uncured polymer-forming composition to the back side of a textile, applying a layer of a non-woven fabric to the polymer backing, and curing the polymer forming composition to a tack free state. In order for the carpet to be releasable when a precoat is used, the adhesion between the precoat and foamable layer has to be sufficient to avoid delamination at that interface. Most commonly, latex-based precoats are used to assure adequate interfacial adhesion; however, these latex materials may potentially contain volatile organic compounds.

Polyurethane unitary layers that may be used as precoats are described, for example, in U.S. Pat. Nos. 4,269,159 and 4,696,849. Polyurethane-backed carpeting is the subject of U.S. Pat. No. 4,296,159. These carpets comprise a primary backing, a yarn tufted or woven through the primary backing to create a bundle on the underside of the tufted good, and a polyurethane composition is then applied to the underside to encapsulate the yarn bundles to the primary backing providing high “tuft lock”. This polyurethane composition comprises a high molecular weight polyether polyol, a low molecular weight polyol, and organic polyisocyanate or polyisothiocyanate, and an inorganic filler. The isocyanate used in the examples are either isocyanate prepolymers based on toluene diisocyanate, or a modified diphenylmethane thioisocyanate.

U.S. Pat. No. 4,696,849 discloses polyurethane compositions suitable for carpet backing comprising the reaction product of a polyurethane-forming composition which comprises at least one relatively high equivalent weight polyol containing an average of about 1.4-1.95 hydroxyl groups per molecule, of which hydroxyl groups at least 30% are primary hydroxyls; a relatively low equivalent weight compound having about 2 active hydrogen containing moieties per molecule; a polyisocyanate and a catalyst. Toluene diisocyanate 2,4- and 4,4-diphenyl methane diisocyanates and the isocyanate-terminated prepolymers thereof are said to be suitable isocyanates. The average functionality of the reactive components (i.e., all the active hydrogen containing components and isocyanates) must range from 1.97 to 2.03.

The production of urethane foams and elastomers is well known in the art. Urethanes are formed when NCO groups react with hydroxyl groups. The most common method of urethane production is via the reaction of a polyol and an isocyanate which forms the backbone urethane group. A cross-linking agent may also be added. Depending on the desired qualities of the final urethane product, the precise formulation may be varied. Variables in the formulation include the type and amounts of each of the reactants.

In the case of a urethane foam, a blowing agent is added to cause gas or vapor to be evolved during the reaction. The blowing agent creates the void cells in the final foam, and may be a relatively low boiling solvent or water. A low boiling solvent evaporates as heat is produced during the isocyanate/polyol reaction to form vapor bubbles. If water is used as a blowing agent, a reaction occurs between the water and the isocyanate group to form an amine and CO₂ gas in the form of bubbles. In either case, as the reaction proceeds and the material solidifies, the vapor or gas bubbles are locked into place to form void cells. Final urethane foam density and rigidity may be controlled by varying the amount or type of blowing agent used.

A cross-linking agent is often used to promote chemical cross-linking to result in a structured final urethane product. The particular type and amount of cross-linking agent used will determine such final urethane properties such as elongation, tensile strength, and tightness of cell structure, tear resistance and hardness. Generally, the degree of cross-linking that occurs correlates to the flexibility of the final foam product. Relatively low molecular weight compounds with greater than single functionality are found to be useful as cross-linking agents. Catalysts may also be added to control reaction times and to effect final product qualities. The effects of catalysts generally include the speed of the reaction. In this respect, the catalyst interplays with the blowing agent to affect the final product density. The reaction should proceed at a rate such that maximum gas or vapor evolution coincides with the hardening of the reaction mass. Also, the effect of a catalyst may include a faster curing time, so that urethane foam may be produced in a matter of minutes instead of hours.

Polyols conventionally used in the production of urethanes are petrochemicals, being generally derived from ethylene glycol with polyester polyols and polyether polyols being the most common polyols used in urethane production. For semi-rigid foams, polyester or polyether polyols with molecular weights of from 3,000 to 6,000 are generally used, while for flexible foams shorter chain polyols with molecular weight of from 600 to 4,000 are generally used. There is a very wide variety of polyester and polyether polyols available for use, with a particular polyol being used to engineer and produce a particular urethane elastomer or foam having desired particular final toughness, durability, density, flexibility, compression set ratio, and modulus and hardness quality. Generally, lower molecular weight polyols and lower functionality polyols tend to produce more flexible foams than do heavier polyols and higher functionality polyols. In order to eliminate the need to produce, store, and use different polyols, it would be advantageous to have a single versatile component that was capable of being used to create final urethane foams of widely varying qualities.

Further, the use of petrochemicals such as polyester or polyether polyols is disadvantageous for a variety of reasons. As petrochemicals are ultimately derived from petroleum, they are a non-renewable resource. The production of a polyol requires a great deal of energy, as oil must be drilled, extracted from the ground, transported to refineries, refined and otherwise processed to yield the polyol. These required efforts add to the cost of polyols, and to the disadvantageous environmental effects of its production. Also, the price of polyols tends to be somewhat unpredictable as it tends to fluctuate based on the fluctuating price of petroleum.

Also, as the consuming public becomes more aware of environmental issues, there are distinct marketing disadvantages to petrochemical-based products. The consumer demand for “greener” products continues to grow.

It would therefore be most advantageous to replace polyester or polyether polyols as used in the production of urethane elastomers and foams with a more versatile, renewable, less costly, and more environmentally friendly component.

Plastics and foams made using fatty acid triglycerides derived from vegetables have been developed, including soybean derivatives. Because soybeans are renewable, relatively inexpensive, versatile, and environmentally friendly, they are desirable as ingredients for plastics manufacture. Soybeans may be processed to yield fatty acid triglyceride rich soy oil and a protein rich soy flour.

Unlike urethanes, many plastics are protein based. For these types of plastics, soy protein based formulations have been developed. U.S. Pat. No. 5,710,190, for instance, discloses the use of soy protein in the preparation of a thermoplastic foam. Such plastics, however, are not suitable for use in applications that call for the particular properties of urethanes. Since urethanes don't utilize proteins in their formulations, soy proteins are not relevant for urethane manufacture.

Epoxidized soy oils in combination with polyols have also been used to formulate plastics and plastic foams, including urethanes. For example, U.S. Pat. No. 5,482,980 teaches use of an epoxidized soy oil in combination with a polyol to produce a urethane foam. A polyester or polyether polyol remains in the formulation, however. Also, as the epoxidation processing of the soy oil requires energy, materials and time, use of an un-modified soy oil would be more advantageous.

Efforts have been made to produce a urethane type cellular plastic from un-modified soy oil. U.S. Pat. Nos. 2,787,601 and 2,833,730 disclose a rigid cellular plastic material that may be prepared using any of several vegetable oils, including soy oil. The foam disclosed in these patents, however, is made from a multistep process requiring the preparation of a prepolymer and, in the case of U.S. Pat. No. 2,833,730, relatively low cross-linker concentrations are urged, resulting in questionable product stability. Further, use of a particular isocyanate, namely toluene diisocyanate, is disclosed which is disadvantageous due to its relatively high toxicity.

An unresolved need therefore exists in industry for a urethane elastomer and a flexible urethane foam, and a method of producing such materials that are based on a reaction between isocyanates and a relatively inexpensive, versatile, renewable, environmentally friendly material such as vegetable oils as a replacement for polyether or polyester polyols.

In copending application Ser. No. 10/059,278 [publication no. 20030143910 (hereinafter “Pub-910”), the disclosure of which is incorporated herein by reference], there is described a carpet backing comprising a textile having at least one adherent polyurethane backing, the backing being prepared from a polyurethane forming composition which comprises: (A) a polyisocyanate and (B) a mixture of a vegetable oil, a cross-linking agent comprised of a multi-functional alcohol present in a ratio to said vegetable oil such that there are at least 0.7 moles of OH groups per mole of bulk vegetable oil, a catalyst, and a blowing agent. One of the difficulties associated with products of the above-described method, however, is that, in order to achieve the best quality products it became necessary to employ some petrol-polyols with the vegetable oils of the invention. Thus, the products were not usually as environmentally friendly as those wherein the polyol was 100% derived from vegetable oils.

It is an object of the invention to provide a flexible urethane foam, useful as an environmentally friendly carpet backing that is an improvement over those of the prior art, particularly those of Pub-910.

It is an object of the present invention to provide precoats, foam coats and laminate coats that are particularly useful as carpet-backings and that optimally combine flexibility and elongation characteristics with rigidity, strength and density requisites.

It is a further object of the invention to provide carpet backings manufactured with materials that are more environmentally friendly than those heretofore utilized.

### SUMMARY OF THE INVENTION

The foregoing and other objects are realized by the present invention, one embodiment of which relates to a cellular material useful in the manufacture of carpet backings that is the reaction product of an A-component and a B-component, wherein the A-component is comprised of an aromatic or aliphatic isocyanate (for example phenyl diisocyanate, 4,4′-biphenylene diisocyanate, 2,4-toluene diisocyanate, 2,6-toluene diisocyanate (TDI) ditoluene diisocyanate, naphthalene 1,4-diisocyanate, 2,4′- and/or 4,4′-diphenylmethane diisocyanate (MDI), polymethylene polyphenylene polyisocyanates (polymeric MDI), 1,6-hexamethylene diisocyanate, isophorone diisocyanate, 1,4-cyclohexyl diisocyanate, or any other modified MDI or TDI or vegetable oil based isocyanate or other prepolymer; and the B-component is comprised of:

1) an environmentally friendly hydroxylated vegetable oil having a functionality of 1-4 (such as from soybeans);

2) a catalyst (amine or metal, for example); and

3) a blowing agent.

Optionally, the B-component may also contain:

5) a surfactant;

6) fillers (e.g., calcium carbonate, aluminum trihydrate and flyash), and

7) pigment.

### DETAILED DESCRIPTION OF THE INVENTION

The present invention is predicated on the discovery that improved urethane foam carpet backings can be prepared by substituting hydroxylated vegetable oils having a functionality of 1-4 for the vegetable oils and cross linkers employed products, compositions and methods of Pub-910. The inclusion of the hydroxylated vegetable oils in the formulations of the invention eliminates the necessity for including petrol-polyols in the mix ion order to achieve optimal results and properties. Moreover, the employment of the hydroxylated vegetable oils also removes the necessity for including cross linkers in the formulation.

The B-component is typically mixed in a standard mix tank and reacted with the A-component (in a one step process) just prior to the point of use. By varying the proportions of the reactants within the B-component and altering the mix with the quantity of A-component, flexibility, rigidity, density and hardness can be controlled (i.e. precoats, foams and laminates acquired). Thus, higher molecular weight and higher functionality isocyanates would result in a less flexible foam than the use of a lower molecular weight and lower functionality isocyanate with the same polyol.

Upon the combination of A-component and B-component reactants an exothermic reaction occurs which may reach completion in several minutes or several hours depending on the reactants and the concentrations used. The catalyst level is altered to accelerate or decelerate the reaction. Also, the blowing agent level is altered to affect the film structure thus forming a foam or polyurethane elastomer.

One embodiment of the invention relates to its utilization as a precoat layer for carpet. Traditionally a carpet can be broadloom, tile or rugs, woven or tufted into a primary substrate which is typically a woven or non woven, made of various fiber types such as polypropylene or polyester. A typical construction, for example, is a broadloom carpet tufted into a woven polypropylene primary. This construction is then percolated (knife over a roll, sprayed, etc.) on the back component with the biobased polyurethane composition of the invention. This is a very critical part of the process where both application and chemical formulation come together in order to accomplish:
1) penetration and surrounding of the carpet tufts, insuring the tuft-primary adhesion and elevated tuft pull strengths;
2) encapsulation of the individual carpet tuft filaments to prevent pilling or fuzzing; and
3) physical stabilization of the carpet composite.

After the point of precoat application, the biobased precoat is finish-cured, e.g., in a heated oven.

Another embodiment of the invention is its use as a coating over an already precoated carpet described in the above embodiment, in order to laminate thereto a secondary substrate. This substrate can be a woven, non-woven or a composite of both, made of various fiber types such as polypropylene, polyester or combinations thereof. After the introduction of the secondary into the biobased coating layer the composite is finished cured in a heated oven.

This laminated construction offers additional physical stability of the carpet composite through the manufacturing process. The laminated construction offers such additional attributes such as:

1) a bondable surface for direct adhesive installation;

2) physical strength needed during stretching in a direct glue installation; and

3) physical strength and integrity in a stretch-in over pins installation.

An additional embodiment of the invention is its utilization as a foam coating over the above-described precoated carpet. The carpet construction in then finished cured in a heated oven. The advantages of having applied foam to the carpet are:

1) comfort under foot,

2) insulation factors; and

3) carpet fiber/life retention increase.

A still further embodiment of the invention is its use as a foam coating over an already precoated carpet construction described above, followed by introducing a secondary into the foam structure. The secondary substrates that can be employed are described hereinabove. The carpet construction is then finish-cured in a heated oven.

Another embodiment of the invention is its employment as a precoat and laminate in a one step-application process.

The A-component comprises a polyisocyanate, and usually is based on diphenylmethane diisocyanate (“MDI”) or toluenediisocyanate (“TDI”). The particular isocyanate chosen will depend on the particular final qualities desired in the urethane. The B-component material is generally a solution of the hydroxylated vegetable oil, catalyst and blowing agent. A catalyst is also generally added to the B-component to control reaction speed and effect final product qualities.

It has been discovered, however, that flexible urethane foams of a high quality can be prepared by substituting the vegetable oils disclosed by Pub-910 with hydroxylated vegetable oils having a functionality of 1-4 and eliminating the multi-functional alcohol cross-linking agent The replacement is made on a substantially 1:1 weight ratio of vegetable oil for replaced petroleum-based polyol. The process of producing the urethane does not change significantly with the previously used vegetable oils and crosslinking agent replaced by the hydroxylated vegetable oil of the present invention; all of the other components and general methods being generally known in the art. The qualities of the final flexible or semi-rigid urethane foam produced using the hydroxylated vegetable oil are consistent with those produced using conventional high grade, expensive petrol-based polyol or mixtures thereof with the vegetable oils of Pub-910.

Further, it has surprisingly been discovered that with use of the hydrogenated vegetable oils of the invention, urethane foams of varying and selectable final qualities, including differing flexibilities, densities, and hardnesses, can be made by varying only the degree of hydrogenation. It would be difficult, if not impossible, to create such varied final foams using a single petroleum-based polyester or polyether polyol with the same variations in the remaining reactants. Instead, different petroleum-based polyols would be required to produce such varied results.

The use of only hydroxylated vegetable oil in the urethane forming reaction also realizes a significant cost savings. Vegetable oils are abundant, renewable, and easily processed commodities, as opposed to polyols, which are petroleum derivatives and which entail significant associated processing costs. As such, they may currently be acquired for a cost of approximately half that of average grade petroleum-based polyester or polyether polyols, and approximately one quarter the cost of high-grade petroleum-based polyester or polyether polyols. Also, as polyols derived from petroleum, they are not renewable and carry a certain environmental cost with them. There is a distinct marketing advantage to marketing products that are based on environmentally friendly, renewable resources such as vegetable oils.

As is well known in the art, functionality=the average number of isocyanate reactive sites per molecule. It is calculated according to the following formula:

Average functionality=(Total moles OH)/(Total moles polyol)

The hydoxyl number is a measure of the amount of reactive hydroxyl groups available for reaction. This value is determined by a wet analytical method and is reported as the number of milligrams of potassium hydroxide equivalent to the hydroxyl groups found in one gram equivalent of the sample:

OH number=(56.1×1000)/equivalent weight

The particular hydroxylated vegetable oil employed depends upon the desired characteristics in the resulting product (generally, the higher the functionality, the harder the compound). Hydroxylated soy oils having, but limited to, the following functionalities may be employed in the practice of the invention:

| Functionality | Hydroxyl |
|---|---|
| 1.0 | 100 |
| 1.3 | 114 |
| 1.5 | 126 |
| 1.8 | 126.5 |
| 2.8 | 155 |
| 3.0 | 167 |
| 3.5 | 180 |
| 4.0 | 186 |

The hydroxylated vegetable oils suitable for use in the present invention are known in the art as shown in the examples. Alternatively, they may be prepared according to the methods of synthesis disclosed in U.S. Pat. Nos. 4,742,112 and 6,583,302; United States Patent Application Publication nos. 2006004115, 20060041156, 20030232956; 20040010095 and 20060041155; Okieimen et al, European Journal of Lipid Science and Technology, Volume 107, Issue 5, Pages 330-336; UK Patent GB2278350B;

http://www.mii.vt.edu/MACRO%202002/MACROP41.htm.

Suitable oils that may be hydroxylated for use according to the present invention include, e.g., soy, corn, safflower, sunflower, palm, cottonseed and the like.

The A-component isocyanate reactant of the urethane of the invention is preferably comprised of a isocyanate chosen from a number of suitable isocyanates as are generally known in the art. Different isocyanates may be selected to result in different final product properties. The A-component reactant of the urethane of the invention preferably comprises diphenylmethane diisocyanate (MDI).

The B-component reactant of the urethane reaction includes at least the hydroxylated vegetable oil and a blowing agent. It is believed that the isocyanate reacts with the fatty acids of the vegetable oil to produce the polymeric backbone of the urethane.

The hydroxylated vegetable oils that are suitable for use are available from Biobased Technologies and described in US application publication no. 20060041155, the entire contents and disclosure of which is incorporated herein by reference. The preferred vegetable oil is soy oil, although it is contemplated that other vegetable oils, such as rapeseed oil (also known as canola oil) and palm oil can be used in accordance with the present invention. Except for the preliminary blowing step where air is passed through the oil to remove impurities and to thicken it and hydroxylation to the desired functionality, the soy oil is otherwise unmodified. It does not require esterification as is required for some urethane products of the prior art.

Except for the use of the preferred unmodified, blown hydroxylated soy oil replacing the polyol, the preferred B-component reactant used to produce the foam of the invention is generally known in the art. Accordingly, preferred blowing agents for the invention are those that are likewise known in the art, and may be chosen from the group comprising 134A HCFC refrigerant available from Dow Chemical Co., Midland Mich., methyl isobutyl ketone (MIBK), acetone and methylene chloride. These preferred blowing agents boil to create vapor bubbles in the reacting mass. Should other blowing agents be used that react chemically, such as water, to produce a gaseous product, concentrations of other reactants may be adjusted to accommodate the reaction.

In addition to the B-component's soy oil and blowing agent, one or more catalysts may be present. Preferred catalysts for the urethanes of the present invention are those that are generally known in the art, and are most preferably tertiary amines chosen from the group comprising DABCO 33-LV (containing 33% of 1,4-diaza-bicyclco-octane and 67% dipropylene glycol) a gel catalyst available from Air Products Corporation; DABCO BL-22 blowing catalyst available from the Air Products Corporation; and POLYCAT 41 trimerization catalyst available from the Air Products Corporation.

Also, as known in the art, the B-component reactant may further comprise a silicone surfactant which functions to influence liquid surface tension and thereby influence the size of the bubbles formed and ultimately the size of the hardened void cells in the final foam product. This can effect foam density and foam rebound (index of elasticity of foam). Also, the surfactant may function as a cell-opening agent to cause larger cells to be formed in the foam. This results in uniform foam density, increased rebound, and a softer foam.

A molecular sieve may further be present to absorb excess water from the reaction mixture. The preferred molecular sieve of the present invention is available under the trade name L-Paste.

The preferred flexible and semi-rigid foams of the invention will have greater than approximately 60% open cells. The preferred flexible foam of the invention will also have a density of from 1 to 45 lb. per cubic foot and a Shore hardness of durometer from 20/70 and 20/95.

As noted above, there is described in copending application Ser. No. 10/059,278 [publication no. 20030143910], a carpet backing comprising a textile having at least one adherent polyurethane backing, the backing being prepared from a polyurethane forming composition which comprises: (A) a polyisocyanate and (B) a mixture of a vegetable oil, a cross-linking agent comprised of a multi-functional alcohol present in a ratio to said vegetable oil such that there are at least 0.7 moles of OH groups per mole of bulk vegetable oil, a catalyst, and a blowing agent. Other disadvantages associated with, e.g., commercially available soy oils utilized for preparing the backings of that invention include:

1) The soy oils contain a significant amount of unreactables (approximately 25 percent), thereby limiting the amount that could be used in the formulation to a maximum of 50 parts.

2) Another issue encountered was that the functionality and hydroxyl content could not be determined exactly and obviously fluctuated from batch to batch because the physical films prepared therefrom would demonstrate various index's changes, although the calculations remained the same.

3) Chain extenders (i.e., dipropylene glycol, tripropylene glycol and ethylene glycol) were required to maintain physical stability.

4) The use of these oils resulted in very high emissions of Volatile Organic Chemicals.

The hydroxylated oils utilized in the practice of the present invention are vastly superior to those previously employed because:

1) They contain a low percentage of unreactants (approximately 5%)

2) The functionally and content of hydroxyls are easily controlled and verifiable.

3) There is no need for chain extenders in the composition.

4) Volatiles are very low to none existent, thereby contributing a very low amount if any to the finished product.

5) The hydroxylated oils utilized in the present invention can be formulated with higher parts of fillers. This attribute allows the formulation, for example of 100 parts Agrol, 100 to 600 pts filler loading and 40 parts ISO. The combination of the stability of soy pricing, the rapid renewable aspect, and the acceptance of filler loading allows the manufacturer to address pricing with acceptable quality where such could not be accomplished with the old system or any petro polyol.

The urethane foam of the present invention is produced by combining the A-component reactant with the B-component reactant in the same manner as is generally known in the art. Advantageously, use of the vegetable oil to replace the petroleum-based polyol does not require significant changes in the method of performing the reaction procedure. Upon combination of the A and B component reactants, a reaction ensues which generates heat, and which may reach completion in anywhere from several minutes to several hours depending on the particular reactants and concentrations used. Typically, the reaction is carried out in a mold so that the foam expands to fill the mold, thereby creating a final foam product in the shape of the mold.

The components may be combined in differing amounts to yield differing results, as will be shown in the Examples presented in the Examples below. Generally, however, the preferred flexible foam of the invention B-component mixture, when using the preferred components, is prepared with the following general weight ratios:

Flexible urethane foams may be produced with differing final qualities using the same vegetable oil by varying the particular other reactants chosen. For instance, it is expected that the use of relatively high molecular weight and high functionality isocyanates will result in a less flexible foam than will use of a lower molecular weight and lower functionality isocyanate when used with the same vegetable oil.

The blowing agent may comprise any conventionally employed in the art and include methyl isobutyl ketone, acetone, water, mechanically frothed air and the like.

The above brief description sets forth rather broadly the more important features of the present disclosure so that the detailed description that follows may be better understood, and so that the present contributions to the art may be better appreciated. There are, of course, additional features of the disclosure that will be described hereinafter which will form the subject matter of the claims appended hereto. In this respect, before explaining the several embodiments of the disclosure in detail, it is to be understood that the disclosure is not limited in its application to the details and the arrangements set forth in the following description. The present invention is capable of other embodiments and of being practiced and carried out in various ways, as will be appreciated by those skilled in the art. Also, it is to be understood that the phraseology and terminology employed herein are for description and not limitation.

The polyurethane coatings may be prepared and applied to textiles in the manner described in the U.S. patents described hereinabove as well as U.S. Pat. No. 6,180,686, the entire contents and disclosures of each of which are incorporated herein by reference.

In the following non-limiting examples, the formulas listed below were employed:

| | | | |
|---|---|---|---|
| 1. | Agrol 1.8 | 75 | parts |
| | Agrol 2.8 | 25 | parts |
| | Viscosity Reducer | 5 | parts |
| | Coal Ash | 500 | parts |
| | Catalyst/carrier | .016 | parts |
| | Isocyanate | 52.97 | parts |
| 2. | Agrol 1.8 | 100 | parts |
| | Viscosity Reducer | 5 | parts |
| | Coal Ash | 500 | parts |
| | Catalyst/carrier | .016 | parts |
| | Isocyanate | 48.9 | parts |
| 3. | Agrol 1.8 | 75 | parts |
| | Agrol 2.8 | 25 | parts |
| | Viscosity Reducer | 5 | parts |
| | Coal Ash | 400 | parts |
| | Catalyst/carrier | .016 | parts |
| | Isocyanate | 50.0 | parts |
| 4. | Agrol 1.8 | 75 | parts |
| | Agrol 2.8 | 25 | parts |
| | Coal Ash | 300 | parts |
| | Catalyst/carrier | .016 | parts |
| | Isocyanate | 48.7 | parts |
| 5. | Agrol 1.8 | 100 | parts |
| | Coal Ash | 300 | parts |
| | Catalyst/carrier | .016 | parts |
| | Isocyanate | 42.5 | parts |
| 6. | Agrol 1.8 | 100 | parts |
| | Catalyst/carrier | .016 | parts |
| | Isocyanate | 42.6 | parts |

The equipment employed to conduct the method consisted of 1) a small batching system that could mix up to 600 lbs. of chemicals for trials (2) a blending head for mixing polyols, iso and side adds (3) an applicator station and (4) an oven to cure the products. It was found that by pre-heating the soy polyol to 150° F. that the viscosity dropped to 80 centipoise and the filler (coal fly ash) could be charged from 200 up to 600 parts.

It was also found that by maintaining temperature at 150° F., agitating and recirculating the compound that the suspension of high filler loads and stabilization of the compound could be maintained indefinitely. It was also advantageous to heat all of the piping from storage to the blending head to maintain the low viscosity of the compound while moving it from storage to process.

By adding the catalyst too soon in a heated compound the reaction was generally too fast for efficient processing. Accordingly, there was developed a mechanical injection system that would deliver the catalyst at the exit side of the blender and just prior to the mixed compound going on the carpet. This system solved three critical needs: 1) finished reaction was maintained 2) compound strength was maximized and 3) processability of mixed compound was managed.

It will be understood by those skilled in the art that any conventional equipment for forming polyurethane foams and applying them to carpets may be employed in the practice of the invention. Exemplary of such equipment is that disclosed in Pub-910.

1. A textile having at least one adherent polyurethane backing, said backing being prepared from a polyurethane forming composition which comprises: (A) a polyisocyanate and (B) a mixture of a hydroxylated vegetable oil having a functionality of 1-4 and a blowing agent.

2. The textile of claim 1 wherein said composition additionally contains a catalyst.

3. The textile of claim 1 wherein said composition additionally contains a filler.

4. The textile of claim 1 wherein said vegetable oil is chosen from the group comprising soy oil, rapeseed oil or palm oil.

5. The textile of claim 1 wherein said vegetable oil comprises blown soy oil.

6. The textile of claim 1 wherein said catalyst is a tertiary amine.

7. The textile of claim 1 wherein the blowing agent is selected from the group consisting of methylisobutyl ketone, acetone, water and mechanically frothed air.

8. The textile of claim 1 wherein said polyisocyanate comprises a diisocyanate.

9. The textile of claim 1 wherein said catalyst is present in the amount of at least 0.016 parts and said poly isocyanate (A) is present in the amount of about 36.85 parts per 600 parts of mixture (B).

10. The textile of claim 9 wherein said mixture (B) contains about 100 parts filler and 500 parts filler.

11. The textile of claim 2 wherein the polyurethane comprises the reaction product of between about 36.85 and about 55.5 parts of (A) and 100 parts of (B) and wherein (A) comprises a diisocyanate and (B) comprises about 100 parts of blown soy oil, about 0.016 to about 0.04 parts catalyst and froth air.

12. The textile of claim 2 wherein said catalyst is chosen from the group comprising a mixture of 33% 1,4-diaza-bicyclo-octane and 67% dipropylene glycol; a tertiary amine blowing catalyst; and n, n′, n″, dimethylamino-propyl-hexahydrotriazine tertiary amine.

13. The textile of claim 1 wherein said polyisocyanate is chosen from the group consisting of 2,4 diisocyanate, 4,4 diphenylmethane diisocyanate and 2,4 diphenylmethane diisocyanate.

14. The textile of claim 1 wherein B further comprises from 0 to about 6 parts surfactant agent for affecting foam cell size.

15. The textile of claim 1 wherein B further comprises from about 3 to about 12 parts molecular sieve agent for absorbing water.

16. The textile of claim 1 wherein B further comprises from about 0 to about 600 parts filler.

17. The textile of claim 1 wherein said polyurethane backing has a coating weight of about 10 to about 40 oz/sq. yd.

18. The textile of claim 1 comprising a primary backing material having a pile attached to one component thereof.

19. The textile of claim 1 comprising a floor covering.

20. The textile of claim 1 wherein a secondary textile substrate is laminated to said at least one polyurethane backing.

21. The textile of claim 19 wherein said secondary textile is a woven, non-woven or composite woven/non-woven textile.

22. The textile of claim 1 wherein said polyurethane backing comprises at least two separately applied polyurethane-forming compositions.

23. The textile of claim 21 wherein a secondary textile is laminated between said at least two polyurethane coatings.

24. The textile of claim 21 wherein a secondary textile is laminated to the outermost polyurethane coating.

25. The textile of claim 23 or 24 wherein said secondary textile is a woven, non-woven or composite woven/non-woven textile.

26. A method of preparing the textile of claim 1 comprising coating a textile with at least one polyurethane forming composition which comprises: (A) a polyisocyanate and (B) a mixture of a hydroxylated vegetable oil and a blowing agent and subjecting said at least one coating to conditions which result in the reaction of (A) and (B) to form said polyurethane.

27. The method of claim 26 wherein (b) also comprises a catalyst.

28. The method of claim 26 wherein (A) comprises a diisocyanate and (B) comprises blown soy oil, a catalyst and a blowing agent.

29. The method of claim 27 wherein (A) comprises a diisocyanate and (B) comprises blown soy oil, a tertiary amine catalyst and a blowing agent.

30. The method of claim 26 wherein the ratio of (A) to (B) is from about 0.9 parts:about 36.85 parts to about 1.3 parts:about 55.5 parts

31. The method of claim 26 wherein a secondary textile substrate is laminated to said at least one polyurethane backing.

32. The method of claim 26 wherein said secondary textile is a woven, non-woven or composite woven/non-woven textile.

33. The method of claim 26 wherein said polyurethane backing comprises at least two separately applied polyurethane-forming compositions.

33. The method of claim 32 wherein a secondary textile is laminated between said at least two polyurethane coatings.

34. The method of claim 32 wherein a secondary textile is laminated to the outermost polyurethane coating.

35. The method of claim 33 or 34 wherein said secondary textile is a woven, non-woven or composite woven/non-woven textile.

36. A polyurethane forming composition suitable for forming an adherent backing on a textile comprising: (A) a polyisocyanate and (B) a mixture of a hydroxylated vegetable oil having a functionality of 1-4 and a blowing agent.

37. The composition of claim 36 wherein said composition additionally contains a catalyst.

38. The composition of claim 36 wherein said composition additionally contains a filler.

39. The composition of claim 36 wherein said vegetable oil is chosen from the group comprising soy oil, rapeseed oil or palm oil.

40. The composition of claim 36 wherein said vegetable oil comprises blown soy oil.

41. The composition of claim 36 wherein said catalyst is a tertiary amine.

42. The composition of claim 36 wherein the blowing agent is selected from the group consisting of methylisobutyl ketone, acetone, water and mechanically frothed air.

43. The composition of claim 36 wherein said polyisocyanate comprises a diisocyanate.

44. The composition of claim 36 wherein said catalyst is present in the amount of at least 0.016 parts and said poly isocyanate (A) is present in the amount of about 36.85 parts per 600 parts of mixture (B).

45. The composition of claim 44 wherein said mixture (B) contains about 100 parts filler and 500 parts filler.

46. The composition of claim 37 wherein the polyurethane comprises the reaction product of between about 36.85 and about 55.5 parts of (A) and 100 parts of (B) and wherein (A) comprises a diisocyanate and (B) comprises about 100 parts of blown soy oil, about 0.016 to about 0.04 parts catalyst and froth air.

47. The composition of claim 37 wherein said catalyst is chosen from the group comprising a mixture of 33% 1,4-diaza-bicyclo-octane and 67% dipropylene glycol; a tertiary amine blowing catalyst; and n, n′, n″, dimethylamino-propyl-hexahydrotriazine tertiary amine.

48. The composition of claim 36 wherein said polyisocyanate is chosen from the group consisting of 2,4 diisocyanate, 4,4 diphenylmethane diisocyanate and 2,4 diphenylmethane diisocyanate.

49. The composition of claim 36 wherein B further comprises from 0 to about 6 parts surfactant agent for affecting foam cell size.

50. The composition of claim 36 wherein B further comprises from about 3 to about 12 parts molecular sieve agent for absorbing water.

51. The composition of claim 36 wherein B further comprises from about 0 to about 600 parts filler.

52. The composition of claim 36 wherein said polyurethane backing has a coating weight of about 10 to about 40 oz/sq. yd.

53. The composition of claim 36 wherein said textile comprises a primary backing material having a pile attached to one component thereof.

54. The composition of claim 36 wherein said textile comprises a floor covering.

55. The composition of claim 36 wherein a secondary composition substrate is laminated to said at least one polyurethane backing.

56. The composition of claim 55 wherein said secondary composition is a woven, non-woven or composite woven/non-woven composition.

57. The composition of claim 36 wherein said polyurethane backing comprises at least two separately applied polyurethane-forming compositions.

58. The composition of claim 57 wherein a secondary composition is laminated between said at least two polyurethane coatings.

59. The composition of claim 57 wherein a secondary composition is laminated to the outermost polyurethane coating.

60. The composition of claim 58 or 59 wherein said secondary composition is a woven, non-woven or composite woven/non-woven composition.

61. The composition of claim 36 wherein said textile comprises a carpet.

62. A polyurethane forming composition suitable for forming an adherent backing on a textile in kit form comprising, in separate packages: (A) a polyisocyanate and (B) a mixture of a hydroxylated vegetable oil having a functionality of 1-4 and a blowing agent.

63. The composition of claim 62 wherein said composition additionally contains a catalyst.

64. The composition of claim 62 wherein said composition additionally contains a filler.

65. The composition of claim 62 wherein said vegetable oil is chosen from the group comprising soy oil, rapeseed oil or palm oil.

66. The composition of claim 62 wherein said vegetable oil comprises blown soy oil.

67. The composition of claim 62 wherein said catalyst is a tertiary amine.

68. The composition of claim 62 wherein the blowing agent is selected from the group consisting of methylisobutyl ketone, acetone, water and mechanically frothed air.

69. The composition of claim 62 wherein said polyisocyanate comprises a diisocyanate.

70. The composition of claim 62 wherein said catalyst is present in the amount of at least 0.016 parts and said poly isocyanate (A) is present in the amount of about 62.85 parts per 600 parts of mixture (B).

71. The composition of claim 70 wherein said mixture (B) contains about 100 parts filler and 500 parts filler.

72. The composition of claim 63 wherein the polyurethane comprises the reaction product of between about 62.85 and about 55.5 parts of (A) and 100 parts of (B) and wherein (A) comprises a diisocyanate and (B) comprises about 100 parts of blown soy oil, about 0.016 to about 0.04 parts catalyst and froth air.

73. The composition of claim 63 wherein said catalyst is chosen from the group comprising a mixture of 33% 1,4-diaza-bicyclo-octane and 67% dipropylene glycol; a tertiary amine blowing catalyst; and n, n′, n″, dimethylamino-propyl-hexahydrotriazine tertiary amine.

74. The composition of claim 62 wherein said polyisocyanate is chosen from the group consisting of 2,4 diisocyanate, 4,4 diphenylmethane diisocyanate and 2,4 diphenylmethane diisocyanate.

75. The composition of claim 62 wherein B further comprises from 0 to about 6 parts surfactant agent for affecting foam cell size.

76. The composition of claim 62 wherein B further comprises from about 3 to about 12 parts molecular sieve agent for absorbing water.

77. The composition of claim 62 wherein B further comprises from about 0 to about 600 parts filler.

78. The composition of claim 62 wherein said polyurethane backing has a coating weight of about 10 to about 40 oz/sq. yd.

79. The composition of claim 62 wherein said textile comprises a primary backing material having a pile attached to one component thereof.

80. The composition of claim 62 wherein said textile comprises a floor covering.

81. The composition of claim 62 wherein a secondary composition substrate is laminated to said at least one polyurethane backing.

82. The composition of claim 81 wherein said secondary composition is a woven, non-woven or composite woven/non-woven composition.

83. The composition of claim 62 wherein said polyurethane backing comprises at least two separately applied polyurethane-forming compositions.

84. The composition of claim 83 wherein a secondary composition is laminated between said at least two polyurethane coatings.

85. The composition of claim 83 wherein a secondary composition is laminated to the outermost polyurethane coating.

86. The composition of claim 58 or 59 wherein said secondary composition is a woven, non-woven or composite woven/non-woven composition.

87. The composition of claim 62 wherein said textile comprises a carpet.

88. An article of manufacture comprising packaging material and a composition contained within said packaging material, wherein said composition is effective for the formation of an adherent backing on a textile, and wherein said packaging material comprises a label which indicates that said composition can be so used, and wherein said composition comprises a polyurethane forming composition comprising: (A) a polyisocyanate and (B) a mixture of a hydroxylated vegetable oil having a functionality of 1-4 and a blowing agent.

89. The article of claim 88 wherein said article additionally contains a catalyst.

90. The article of claim 88 wherein said article additionally contains a filler.

91. The article of claim 88 wherein said vegetable oil is chosen from the group comprising soy oil, rapeseed oil or palm oil.

92. The article of claim 88 wherein said vegetable oil comprises blown soy oil.

93. The article of claim 88 wherein said catalyst is a tertiary amine.

94. The article of claim 88 wherein the blowing agent is selected from the group consisting of methylisobutyl ketone, acetone, water and mechanically frothed air.

95. The article of claim 88 wherein said polyisocyanate comprises a diisocyanate.

96. The article of claim 88 wherein said catalyst is present in the amount of at least 0.016 parts and said poly isocyanate (A) is present in the amount of about 88.85 parts per 600 parts of mixture (B).

97. The article of claim 96 wherein said mixture (B) contains about 100 parts filler and 500 parts filler.

98. The article of claim 89 wherein the polyurethane comprises the reaction product of between about 88.85 and about 55.5 parts of (A) and 100 parts of (B) and wherein (A) comprises a diisocyanate and (B) comprises about 100 parts of blown soy oil, about 0.016 to about 0.04 parts catalyst and froth air.

99. The article of claim 89 wherein said catalyst is chosen from the group comprising a mixture of 33% 1,4-diaza-bicyclo-octane and 67% dipropylene glycol; a tertiary amine blowing catalyst; and n, n′, n″, dimethylamino-propyl-hexahydrotriazine tertiary amine.

100. The article of claim 88 wherein said polyisocyanate is chosen from the group consisting of 2,4 diisocyanate, 4,4 diphenylmethane diisocyanate and 2,4 diphenylmethane diisocyanate.

101. The article of claim 88 wherein B further comprises from 0 to about 6 parts surfactant agent for affecting foam cell size.

102. The article of claim 88 wherein B further comprises from about 3 to about 12 parts molecular sieve agent for absorbing water.

103. The article of claim 88 wherein B further comprises from about 0 to about 600 parts filler.

104. An article of manufacture comprising a textile having an adherent polyurethane backing said backing being prepared from a polyurethane forming composition which comprises: (A) a polyisocyanate and (B) a mixture of a hydroxylated vegetable oil having a functionality of 1-4 and a blowing agent.

105. The article of claim 104 wherein said polyurethane backing has a coating weight of about 10 to about 40 oz/sq. yd.

106. The article of claim 104 wherein said textile comprises a primary backing material having a pile attached to one component thereof.

107. The article of claim 104 wherein said textile comprises a floor covering.

108. The article of claim 62 wherein a secondary article substrate is laminated to said at least one polyurethane backing.

109. The article of claim 108 wherein said secondary article is a woven, non-woven or composite woven/non-woven article.

110. The article of claim 104 wherein said polyurethane backing comprises at least two separately applied polyurethane-forming articles.

111. The article of claim 110 wherein a secondary article is laminated between said at least two polyurethane coatings.

112. The article of claim 110 wherein a secondary article is laminated to the outermost polyurethane coating.

113. The article of claim 111 or 112 wherein said secondary article is a woven, non-woven or composite woven/non-woven article.

114. The article of claim 104 comprising a carpet.
